(19) United States
(12) Patent Application Publication
(10) Pub. No.: US 2025/0362742 A1
(43) Pub. Date: Nov. 27, 2025

(54) MODIFYING PEDESTRIAN PERCEPTION OF A VEHICLE

(71) Applicant: Toyota Motor Engineering & Manufacturing North America, Inc., Plano, TX (US)

(72) Inventors: Benjamin Piya Austin, Saline, MI (US); Rohit Gupta, Santa Clara, CA (US); Kim Khoa Nguyen, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/671,409

(22) Filed: May 22, 2024

(51) Int. Cl. G06F 3/01; B60W 30/14; G06T 19/00; G06T 19/20

(52) U.S. Cl. CPC G06F 3/013; B60W 30/146; G06T 19/006; G06T 19/20; B60W 2520/06; B60W 2554/4029; G06T 2219/2016

(57) ABSTRACT

A pedestrian's perceived feeling of safety in a driving environment can be improved. It can be determined whether an eye trajectory of a pedestrian moves toward a direction that is opposite a travel direction of a vehicle. In response to determining that the eye trajectory of the pedestrian moves toward the direction that is opposite a travel direction of a vehicle, a perception of the vehicle by the pedestrian can be caused to be modified. Such causing can include causing a behavior of the vehicle to be modified or causing a size of the vehicle presented in an augmented reality display device worn by the pedestrian to the modified.

### FIELD

The subject matter described herein relates in general to vehicles and, more particularly, to the interaction between vehicles and pedestrians.

### BACKGROUND

Some vehicles include an operational mode in which a computing system is used to navigate and/or maneuver the vehicle along a travel route with minimal or no input from a human driver. Such vehicles include sensors that are configured to detect information about the surrounding environment, including the presence of objects in the environment. The computing systems are configured to process the detected information to determine how to navigate and/or maneuver the vehicle through the surrounding environment.

### SUMMARY

In one respect, the present disclosure is directed to a method. The method can include determining whether an eye trajectory of a pedestrian moves toward a direction that is opposite a travel direction of a vehicle. The method can include, responsive to determining that the eye trajectory of the pedestrian moves toward the direction that is opposite a travel direction of a vehicle, causing a perception of the vehicle by the pedestrian to be modified.

In another respect, the present disclosure is directed to a system. The system can include one or more processors programmed to initiate executable operations. The executable operations can include determining whether an eye trajectory of a pedestrian moves toward a direction that is opposite a travel direction of a vehicle. The executable operations can include, responsive to determining that the eye trajectory of the pedestrian moves toward the direction that is opposite a travel direction of a vehicle, causing a perception of the vehicle by the pedestrian to be modified.

### BRIEF DESCRIPTION OF THE DRAWINGS

FIG. 1 is an example of a vehicle.

FIG. 2 is an example of a system for modifying pedestrian perception of a vehicle.

FIG. 3 is an example of a first method of modifying pedestrian perception of a vehicle.

FIG. 4 is an example of a second method of modifying pedestrian perception of a vehicle.

FIG. 5 is an example of a scenario in which a vehicle is approaching an intersection with a pedestrian.

FIG. 6 is an example of a scenario in which a vehicle is approaching an intersection with a pedestrian wearing an extended reality headset.

FIG. 7 is an example of a pedestrian's view of the vehicle within the extended reality headset, showing a size of an extended reality representation of the vehicle being modified.

### DETAILED DESCRIPTION

Autonomous vehicle are expected to become increasingly more prevalent in society. Currently, pedestrians and autonomous vehicles do not have much experience in dealing with each other. Even when they are not interacting with autonomous vehicles, pedestrians may feel compromised feelings of safety in the presence of highly automated autonomous vehicles (e.g., SAE Level 4 or 5 of Society of Automotive Engineers (SAE) SAE J3016 Levels of Driving Automation) due to the lack of presence of a human driver.

In addition to (and interacting with) this aspect, perceived speed profiles of a vehicle may also have a profound effect on feelings of safety, where speeds that are perceived as faster are associated with lower levels of feelings of safety. For pedestrians, speed profiles are perceived differently depending on the eye velocity relative to the vehicle motion and the size of the vehicle. Accordingly, when a pedestrian's gaze moves to face more toward an approaching vehicle, the pedestrian may perceive the vehicle as moving faster than it actually is and can appear more threatening, leading to negative impacts on feelings of safety. These and other effects are described in Turano et al., “Eye movements affect the perceived speed of visual motion,” Vision Research 39 (1999), pp. 1177-1187, which is incorporated herein by reference in its entirety.

Thus, arrangements described here are directed to improving a pedestrian's perceived feeling of safety based on a travel direction of a vehicle in relation to a direction of travel of the pedestrian's eye movements. Accordingly, arrangements described herein include determining whether an eye trajectory of a pedestrian moves toward a direction that is opposite a travel direction of a vehicle. Responsive to determining that the eye trajectory of the pedestrian moves toward the direction that is opposite a travel direction of a vehicle, arrangements described herein can cause a perception of the vehicle by the pedestrian to be modified.

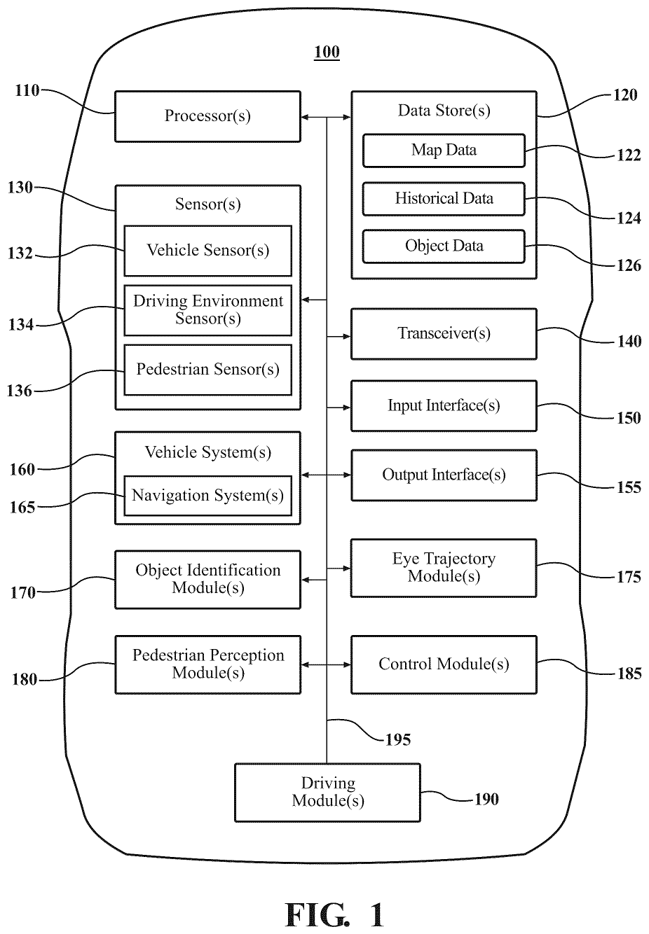

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Arrangements described herein can be used in connection with any moving object in a traffic environment. For instance, arrangements described herein can be used in connection with a vehicle. Referring to FIG. 1, an example of a vehicle 100 is shown. The term “vehicle” means any form of transport, now known or later developed. The vehicle can be a form of motorized transport. Non-limiting examples of vehicles include automobiles, motorcycles, aerocars, or any other form of motorized transport. While arrangements herein will be described in connection with land-based vehicles, it will be appreciated that arrangements are not limited to land-based vehicles. Indeed, in some arrangements, the vehicle can be water-based or air-based vehicles.

The vehicle 100 may be operated manually by a human driver, semi-autonomously by a mix of manual inputs from a human driver and autonomous inputs by one or more vehicle computers, fully autonomously by one or more vehicle computers, or any combination thereof. The vehicle 100 can be configured to switch between these different operational modes.

In one or more arrangements, the vehicle 100 can operate according to any level of autonomy, such as any level as defined by the Society of Automotive Engineers (SAE) SAE J3016 Levels of Driving Automation (e.g., SAE Levels 0-5). In some examples, arrangements described herein can be used in connection with a vehicle operating according to SAE Levels 4 and 5 of autonomy. However, it will be understood that arrangements described herein are not limited in this regard.

The vehicle 100 can include various elements. Some of the possible elements of the vehicle 100 are shown in FIG. 1 and will now be described. It will be understood that it is not necessary for the vehicle 100 to have all of the elements shown in FIG. 1 or described herein. The vehicle 100 can have any combination of the various elements shown in FIG. 1. Further, the vehicle 100 can have additional elements to those shown in FIG. 1. In some arrangements, the vehicle 100 may not include one or more of the elements shown in FIG. 1. Further, while the various elements can be located on or within the vehicle 100, it will be understood that one or more of these elements can be located external to the vehicle. Thus, such elements are not located on, within, or otherwise carried by the vehicle 100. Further, the elements shown may be physically separated by large distances. Indeed, one or more of the elements can be located remote from the vehicle 100.

The vehicle 100 can include one or more processors 110, one or more data stores 120, one or more sensors 130, one or more transceivers 140, one or more input interfaces 150, one or more output interfaces 155, one or more vehicle systems 160, one or more object identification modules 170, one or more eye trajectory modules 175, one or more pedestrian perception modules 180, one or more control modules 185, and/or one or more driving modules 190. Each of these elements will be described in turn below.

As noted above, the vehicle 100 can include one or more processors 110. “Processor” means any component or group of components that are configured to execute any of the processes described herein or any form of instructions to carry out such processes or cause such processes to be performed. The processor(s) 110 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors can work in combination with each other.

The vehicle 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

In one or more arrangements, the data store(s) 120 can include map data 122. The map data 122 can include maps of one or more geographic areas. In some instances, the map data 122 can include information or data on roads, traffic control devices, road markings, streetlights, structures, features, and/or landmarks in the one or more geographic areas. The map data 122 can include measurements, dimensions, distances, positions, coordinates, and/or information for one or more items included in the map data 122 and/or relative to other items included in the map data 122. The map data 122 can include a digital map with information about road geometry. In one or more arrangement, the map data 122 can include information about the ground, terrain, roads, surfaces, and/or other features of one or more geographic areas. The map data 122 can include elevation data in the one or more geographic areas. The map data 122 can define one or more ground surfaces, which can include paved roads, unpaved roads, land, and other things that define a ground surface. The map data 122 can be high quality and/or highly detailed. The map data 122 can include a classification of environment type for geographic areas. The environment type can include rural, urban, and suburban.

In one or more arrangements, the data store(s) 120 can include historical data 124. The historical data 124 can include any information relating to pedestrian traffic in an area. For instance, the historical data can include data about whether pedestrians are present and/or the number of pedestrians present in an area (e.g., at a particular spot, street, intersection, or within a radius or other area) at a particular time of day, during a particular time of year, on a particular day of the week, during a particular month of the year, during particular weather conditions (e.g., temperature, precipitation, humidity, etc.), and/or during other conditions (e.g., an event, construction, etc.). The historical data 124 can include data acquired previously by the sensors of the vehicle 100, data acquired by other vehicles, data acquired by infrastructure devices, data from public and/or private sources, or any combination thereof.

In one or more arrangements, the data store(s) 120 can include object data 126. The object data 126 can include information about a plurality of different objects, including objects that may be found in an external environment of the vehicle 100. Examples of the object data 126 can include vehicles, pedestrians, extended reality devices, animals, buildings, structures, roads, medians, signs, streetlights, traffic lights, traffic signs, road signs, billboards, bridges, poles, towers, trees, and/or plants, just to name a few possibilities. The object data 126 can include one or more images of the objects. The object data 126 can include size, measurements, and/or dimensions of the objects, including averages, percentiles, and ranges. The object data 126 can include any information about an object that can help to identify such an object when detected by one or more sensors. The object data 126 can include images and/or video.

The vehicle 100 can include one or more sensors 130. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the vehicle 100 includes a plurality of sensors, the sensors can work independently from each other. Alternatively, two or more of the sensors can work in combination with each other. In such case, the two or more sensors can form a sensor network.

The sensor(s) 130 can include any suitable type of sensor. Various examples of different types of sensors will be described herein. However, it will be understood that the embodiments are not limited to the particular sensors described.

The sensor(s) 130 can include one or more vehicle sensors 132. The vehicle sensor(s) 132 can detect, determine, assess, monitor, measure, quantify and/or sense information about the vehicle 100 itself (e.g., position, location, orientation, speed, acceleration, heading, trajectory, etc.). The vehicle sensor(s) 132 can be any suitable sensor, now known or later developed. In one or more arrangements, the vehicle sensor(s) 132 can include one or more speedometers. In one or more arrangements, the vehicle sensor(s) 132 can include one or more trajectory sensors.

The sensor(s) 130 can include one or more driving environment sensors 134. Such sensors can be used to detect, determine, assess, monitor, measure, quantify, acquire, and/or sense, directly or indirectly, something about the external environment of the vehicle 100. For instance, the driving environment sensor(s) 134 can be used to detect, determine, assess, monitor, measure, quantify, acquire, and/or sense, directly or indirectly, the presence of one or more objects in the external environment of the vehicle 100, the position or location of each detected object relative to the vehicle 100, the distance between each detected object and the vehicle 100 in one or more directions (e.g. in a longitudinal direction, a lateral direction, and/or other direction(s)), the elevation of a detected object, the speed of a detected object, the acceleration of a detected object, the heading angle of a detected object, and/or the movement of each detected obstacle.

The driving environment sensor(s) 134 can be any suitable sensor, now known or later developed. In one or more arrangements, the driving environment sensor(s) 134 can include one or more radar sensors, one or more lidar sensors, one or more sonar sensors, and/or one or more cameras.

The sensor(s) 130 can include one or more pedestrian sensors 136. The pedestrian sensor(s) 136 can be configured to detect, determine, assess, monitor, measure, quantify and/or sense information about a pedestrian in an external environment of the vehicle 100. In some arrangements, the pedestrian sensor(s) 136 can be configured to acquire data about a pedestrian's gaze, eye movements, eye trajectory, etc. and changes thereto and/or data indicative of a pedestrian's gaze, eye movements, eye trajectory, etc. and changes thereof. Such data will be referred to herein as “eye trajectory data.” In some arrangements, the pedestrian sensor(s) 136 can be configured to acquire data about a pedestrian's position or location in an environment. In some arrangements, the pedestrian sensor(s) 136 can be configured to monitor one or more pedestrians in the external environment of the vehicle 100 continuously, periodically, irregularly, or even randomly.

The pedestrian sensor(s) 136 can be any suitable sensor, now known or later developed. In one or more arrangements, the pedestrian sensor(s) 136 can include one or more cameras, one or more pedestrian detection sensors (e.g., pedestrian presence, location, etc.), one or more long range infrared eye trackers, one or more eye sensors, one or more face sensors, one or more head sensors, one or more eye movement sensors, one or more eye tracking sensors, one or more eye position sensors, one or more eye orientation sensors, one or more head movement sensors, one or more head tracking sensors, one or more head position sensors, one or more head orientation sensors, one or more gaze sensors, and/or one or more gaze tracking sensors, just to name a few possibilities. The pedestrian sensor(s) 136 can be configured to detect, determine, assess, monitor, measure, quantify and/or sense information about a pedestrian and, more particularly, the direction that a person is looking and changes in the direction the person is looking. In some arrangements, the pedestrian sensor(s) 136 can be configured to monitor a pedestrian continuously, periodically, irregularly, or even randomly. The pedestrian sensor(s) 136 and/or the processor(s) 110 can be configured to determine the line of sight of a pedestrian, for example, the direction in which the pedestrian is looking and changes in the direction in which the pedestrian is looking.

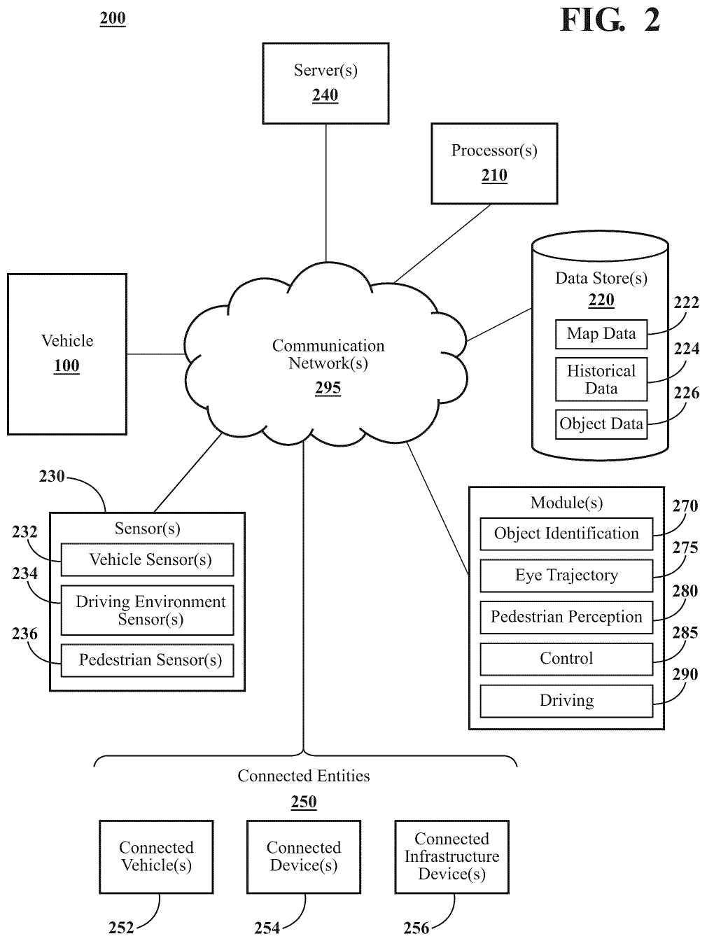

The vehicle 100 can include one or more transceivers 140. As used herein, “transceiver” is defined as a component or a group of components that transmit signals, receive signals or transmit and receive signals, whether wirelessly or through a hard-wired connection. The transceiver(s) 140 can enable communications between the vehicle 100 and other elements, such as one or more of the elements of the system 200 of FIG. 2. The transceiver(s) 140 can be any suitable transceivers used to access a network, access point, node or other device for the transmission and receipt of data. The transceiver(s) 140 may be wireless transceivers using any one of a number of wireless technologies, now known or in the future.

The vehicle 100 can include one or more input interface(s) 150. An “input interface” includes any device, component, system, element or arrangement or groups thereof that enable information/data to be entered into a machine. The input interface(s) 150 can receive an input from a user (e.g., a person, a vehicle occupant, etc.). Any suitable input interface(s) 150 can be used, including, for example, a keypad, display, touch screen, multi-touch screen, button, joystick, mouse, trackball, microphone and/or combinations thereof.

The vehicle 100 can include one or more output interface(s) 155. An “output interface” includes any device, component, system, element or arrangement or groups thereof that enable information/data to be presented to a user (e.g., a person, a vehicle occupant, etc.). The output interface(s) 155 can present information/data to the user. The output interface(s) 155 can include a display. Alternatively or in addition, the output interface(s) 155 may include an earphone and/or speaker. Some components of the vehicle 100 may serve as both a component of the input interface(s) 150 and a component of the output interface(s) 155.

The vehicle 100 can include one or more vehicle systems 160. The one or more vehicle systems 160 can include a propulsion system, a braking system, a steering system, throttle system, a transmission system, a signaling system, and/or a navigation system 165. Each of these systems can include one or more mechanisms, devices, elements, components, systems, and/or combination thereof, now known or later developed. The above examples of the vehicle systems 160 are non-limiting. Indeed, it will be understood that the vehicle systems 160 can include more, fewer, or different vehicle systems. It should be appreciated that although particular vehicle systems are separately defined, each or any of the systems or portions thereof may be otherwise combined or segregated via hardware and/or software within the vehicle 100.

The navigation system 165 can include one or more mechanisms, devices, elements, components, systems, applications and/or combinations thereof, now known or later developed, configured to determine the geographic location of the vehicle 100, to determine a heading or travel direction of the vehicle 100, and/or to determine a travel route for the vehicle 100. The navigation system 165 can include one or more mapping applications to facilitate such determinations. The navigation system 165 can include a global positioning system, a local positioning system, or a geolocation system. The navigation system 165 can be implemented with any one of a number of satellite positioning systems, now known or later developed, including, for example, the United States Global Positioning System (GPS). Further, the navigation system can use Transmission Control Protocol (TCP) and/or a Geographic information system (GIS) and location services.

The navigation system 165 may include a transceiver configured to estimate a position of the vehicle 100 with respect to the Earth. For example, the navigation system 165 can include a GPS transceiver to determine the vehicle's latitude, longitude and/or altitude. The navigation system 165 can use other systems (e.g., laser-based localization systems, inertial-aided GPS, and/or camera-based localization) to determine the location of the vehicle 100.

The vehicle 100 can include one or more modules, at least some of which will be described herein. The modules can be implemented as computer readable program code that, when executed by a processor, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively or in addition, one or more data store 120 may contain such instructions.

The vehicle 100 can include one or more modules, at least some of which will be described herein. The modules can be implemented as computer readable program code that, when executed by a processor, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively or in addition, one or more data store 120 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more object identification modules 170. The object identification module(s) 170 can analyze sensor data captured by the sensor(s) 130 (e.g., the driving environment sensor(s) 134, the pedestrian sensor(s) 136) to detect and/or identify an object in the external environment of the vehicle 100. The object identification module(s) 170 can use any suitable technique, including, for example, template matching and other kinds of computer vision and/or image processing techniques and/or other artificial or computational intelligence algorithms or machine learning methods. The object identification module(s) 170 can include any suitable object recognition software. The object identification module(s) 170 can query the object image database for possible matches. For instance, images, video, or other data captured by the driving environment sensor(s) 134 and/or the pedestrian sensor(s) 136 can be compared to the object data 126 in the data store(s) 120 or other source for possible matches. Alternatively or additionally, measurements or other aspects of an object in the data captured by the driving environment sensor(s) 134 and/or the pedestrian sensor(s) 136 can be compared to measurements or other aspects of the object data 126.

The object identification module(s) 170 can identify a detected object as a particular object if there is a match between the captured image/data of the object and the object data 126. “Match” or “matches” means that an image or other information collected by the sensor(s) 130 and one or more of the images or other information in the object data 126 are substantially identical. For instance, an image or other information collected by the sensor(s) 130 and one or more of the images or other information in the object data 126 can match within a predetermined probability (e.g., at least about 85%, at least about 90%, at least about 95% or greater) or within a confidence level. In one or more arrangements, the detected object can be compared to identifying features of an object, such as color measured visually, shape, size, outline, movement, sounds, dimensions, etc.

Alternatively or additionally, the object identification module(s) 170 can use semantic segmentation on the video captured by the driving environment sensor(s) 134 and/or the pedestrian sensor(s) 136. Thus, the object identification module(s) 170 can interpret pixels in the video into a semantic meaning. The object identification module(s) 170 can be configured to define or label individual pixels in the video as belonging to an individual object. In some arrangements, the object identification module(s) 170 can be configured to identify any pedestrian in the data captured by the driving environment sensor(s) 134 and/or the pedestrian sensor(s) 136.

In some arrangements, the object identification module(s) 170 can be configured to identify any extended reality device worn or otherwise carried by a pedestrian in the data captured by the driving environment sensor(s) 134 and/or the pedestrian sensor(s) 136. Extended reality refers to any combination of real-and-virtual environments. Examples of extended reality include augmented reality, mixed reality, virtual reality, any type of reality in between these types of extended reality, and/or any type of extended reality now known or later developed.

Examples of extended reality devices can include a head mounted display, an extended reality headset, smart eyeglasses, smart goggles, gaze tracking enabled goggles, and smart contact lenses. In some arrangements, the extended reality devices can include a video pass through display in which real-time video of the real-world environment can be passed through to the headset. The video can be augmented in some manner, such as by providing further content in place of, in addition to, overlaid on, and/or a modification of real-world video content.

The vehicle 100 can include one or more eye trajectory modules 175. The eye trajectory module(s) 175 can be configured to analyze eye trajectory data acquired by the sensor(s) 130. The eye trajectory module(s) 175 can be configured to determine a direction that a pedestrian is looking and changes in the direction the person is looking. Such determining can be performed continuously, periodically, irregularly, or even randomly. The eye trajectory module(s) 175 can track the direction that the pedestrian is looking and/or changes in the direction that the pedestrian is looking over time.

The eye trajectory module(s) 175 can be configured to analyze pedestrian data acquired by the pedestrian sensor(s) 136. Using the pedestrian data, the eye trajectory module(s) 175 can be configured to determine an eye trajectory of the pedestrian. The “eye trajectory” can include a direction that a pedestrian is looking, such as a pedestrian's line of sight, and/or changes in the direction the pedestrian is looking. The eye trajectory module(s) 175 can be configured to do so based on a head position, head orientation, head movements, body position, body orientation, body movements, eye position, eye orientation, eye movements, nose position, nose orientation, nose movements, face position, face orientation, face movements, and/or gaze direction of a pedestrian and/or a position, orientation, and/or movement of an extended reality device worn or otherwise carried by the pedestrian. For instance, if a pedestrian's head orientation is known from the pedestrian data, then the eye trajectory module(s) 175 can determine that the pedestrian's line of sight is in line with the direction that the pedestrian's head is facing. As another example, if a pedestrian's eye movements are tracked, then the eye trajectory module(s) 175 can determine that the pedestrian's line of sight is in the direction of the pedestrian's eye movements. Such determining can be performed using any suitable techniques, now known or later developed.

The vehicle 100 can include one or more pedestrian perception modules 180. The pedestrian perception module(s) 180 can determine whether the eye trajectory of a pedestrian moves toward a direction that is opposite the travel direction of the vehicle 100. “Moves toward a direction that is opposite the travel direction of a vehicle” means any movement of the eye trajectory toward facing the direction of an oncoming vehicle. “Moves toward” can include full turns and partially turns of the pedestrian's body, head, face, or eyes to the direction facing the vehicle. In some arrangements, “moves toward a direction that is opposite the travel direction of a vehicle” means any movement of the pedestrian that causes the angle between the pedestrian eye trajectory and the travel direction of the vehicle 100 to decrease. In some arrangements, “moves toward a direction that is opposite the travel direction of a vehicle” means any movement of the pedestrian that causes the angle between the pedestrian eye trajectory and the travel direction of the vehicle 100 to decrease to about 135 degrees or less, about 130 degrees or less, about 125 degrees or less, about 120 degrees or less, about 115 degrees or less, about 110 degrees or less, about 105 degrees or less, about 100 degrees or less, about 95 degrees or less, about 90 degrees or less, about 85 degrees or less, about 80 degrees or less, about 75 degrees or less, about 70 degrees or less, about 65 degrees or less, about 60 degrees or less, about 55 degrees or less, about 50 degrees or less, about 45 degrees or less, about 40 degrees or less, about 35 degrees or less, about 30 degrees or less, about 25 degrees or less, about 20 degrees or less, about 15 degrees or less, about 10 degrees or less, about 9 degrees or less, about 8 degrees or less, about 7 degrees or less, about 6 degrees or less, about 5 degrees or less, about 4 degrees or less, about 3 degrees or less, about 2 degrees or less, or about 1 degree or less.

The pedestrian perception module(s) 180 can compare the eye trajectory (or changes to the eye trajectory) of a pedestrian to the travel direction of the vehicle 100. The pedestrian perception module(s) 180 can compare the eye trajectory (or changes to the eye trajectory) of the pedestrian to the travel direction of the vehicle 100 at substantially the same moment in time. Such comparing can be performed continuously, periodically, irregularly, or even randomly.

When the pedestrian perception module(s) 180 determines that the eye trajectory of a pedestrian is not moving toward a direction that is opposite the travel direction of the vehicle, then the pedestrian perception module(s) 180 can take no action. When the pedestrian perception module(s) 180 determines that the eye trajectory of a pedestrian is moving away from a direction that is opposite the travel direction of the vehicle, then the pedestrian perception module(s) 180 can take no action. When the pedestrian perception module(s) 180 determines that the eye trajectory of a pedestrian moves toward a direction that is opposite the travel direction of the vehicle, then the pedestrian perception module(s) 180 can take action to cause the pedestrian's perception of the vehicle 100 to be modified. Examples of ways in which the pedestrian perception of the vehicle 100 can be modified are described in connection with the control module(s) 185 and the driving module(s) 190.

The modification of the pedestrian's perception of the vehicle 100 can continue for any suitable duration. For instance, in some arrangements, the modification of the pedestrian's perception can continue until the pedestrian looks away from the vehicle. In some arrangements, the modification of the pedestrian's perception can continue until the eye trajectory of the pedestrian moves toward a direction that is the same as the travel direction of a vehicle. In some arrangements, the modification of the pedestrian's perception of the vehicle can continue until the vehicle passes the pedestrian.

The pedestrian perception module(s) 180 can consider other factors in determining whether to modify and/or the degree of modification of a pedestrian's perception of the vehicle is needed. Various example factors will be described in turn below.

For instance, the pedestrian perception module(s) 180 can determine whether the vehicle 100 is approaching the pedestrian. If the pedestrian perception module(s) 180 determine that the vehicle 100 is not approaching the pedestrian, then no action may be taken. Thus, no modification to the pedestrian's perception of the vehicle 100 would occur. If the pedestrian perception module(s) 180 determines that the vehicle 100 is approaching the pedestrian, then the pedestrian perception module(s) 180 can determine whether the eye trajectory of a pedestrian moves toward a direction that is opposite the travel direction of the vehicle, or the pedestrian perception module(s) 180 can take action to cause the pedestrian's perception of the vehicle 100 to be modified.

In some arrangements, the pedestrian perception module(s) 180 can consider the type of environment in which the vehicle is operating. For instance, in rural areas, the presence of vehicles may be less common, especially for autonomous vehicle. In such areas, pedestrians may be more startled (e.g., higher perceived speed of vehicle and associated threat) by approaching vehicles compared to pedestrians in urban environments who may see many cars every day. When the vehicle is located in a rural environment, the pedestrian perception module(s) 180 can include instructions or commands to cause a higher degree of modification to a pedestrian's perception of the vehicle 100. When the vehicle 100 is located in an urban or suburban environment, then the pedestrian perception module(s) 180 may not take any action to alter the degree of modification to a pedestrian's perception of the vehicle 100.

The pedestrian perception module(s) 180 can identify the type of environment in which the vehicle 100 is operating in various ways. As an example, the pedestrian perception module(s) 180 can compare a current location of the vehicle to the map data 122, which can indicate the type of environment the vehicle is currently located in. As another example, the vehicle 100 can review sensor data acquired by the sensor(s) 130 and, more particularly, the driving environment sensor(s) 134. If the sensor data is consistent with a certain type of environment, then the pedestrian perception module(s) 180 can determine that the vehicle is located in that type of environment.

In some arrangements, the pedestrian perception module(s) 180 can consider the risk tolerance of a pedestrian in the environment. For instance, the vehicle 100 can be configured to received pedestrian information, such as from a pedestrian's personal communication device or from a data store. Such information can be shared by the pedestrian with the vehicle 100. The pedestrian perception module(s) 180 can be configured to review pedestrian information, which can include phone habits, phone usage data, and/or calendar information. As an example, if the pedestrian information reveals that the pedestrian participates in a dangerous activity (e.g., rock climbing, sky diving, etc.), then the pedestrian perception module(s) 180 can determine that the pedestrian has a high risk tolerance. In such case, the pedestrian perception module(s) 180 can determine that the pedestrian's perception does not need to be modified or can be modified less than the standard amount. On the other hand, if the pedestrian information reveals that the pedestrian is risk averse or reclusive, then the pedestrian perception module(s) 180 can determine that the pedestrian has a low risk tolerance. In such case, the pedestrian perception module(s) 180 can determine that the pedestrian's perception can be modified by a standard amount or by more than a standard amount.

In some arrangements, the pedestrian perception module(s) 180 can consider the physiological aspects of the pedestrian. For instance, the pedestrian perception module(s) 180 can be configured to analyze physiological data about a pedestrian. Non-limiting examples of physiological data include heart rate, blood pressure, O2 level, electrocardiogram (ECG), and galvanic skin response (GSR). The physiological data can be received from a device worn or carried by the pedestrian. The pedestrian perception module(s) 180 can be configured to analyze the physiological response of a pedestrian in instances where the eye trajectory of the pedestrian moves toward a direction that is opposite the travel direction of the vehicle 100. The pedestrian perception module(s) 180 can detect larger than normal responses. When the physiological data indicates that a pedestrian is startled by the approaching vehicle, then the pedestrian perception module(s) 180 can determine that the pedestrian's perception can be modified by more than a standard amount.

In some arrangements, the pedestrian perception module(s) 180 can consider the physical characteristics of the driving environment of the vehicle 100. The physical characteristics of the driving environment can be obtained from the map data 122 and/or from sensor data acquired by the driving environment sensor(s) 134. When the pedestrian perception module(s) 180 determine that the risk to the pedestrian is low, then the pedestrian perception module(s) can determine that the pedestrian's perception does not need to be modified or can be modified less than the standard amount. When the pedestrian perception module(s) 180 determine that the risk to the pedestrian is high, then the pedestrian perception module(s) 180 can determine that the pedestrian's perception can be modified by a standard amount or by more than a standard amount.

As an example, if the pedestrian is determined to be located at a large boulevard with a large median and the vehicle 100 is approaching the pedestrian on the other side of the median, then the pedestrian perception module(s) 180 can determine that the risk to the pedestrian is low, as there is little or no possibility that the vehicle will collide with the pedestrian. Accordingly, the pedestrian perception module(s) can determine that the pedestrian's perception does not need to be modified or can be modified less than the standard amount.

As another example, if the vehicle 100 is approaching a pedestrian on a dirt road with no sidewalks, then the pedestrian perception module(s) 180 can be determine that the risk to the pedestrian is high. Accordingly, the pedestrian perception module(s) 180 can determine that the pedestrian's perception can be modified by a standard amount or by more than a standard amount.

It will be appreciated that, in some instances, it may not be possible to identify pedestrian(s) in the external environment of the vehicle 100. For instance, the sensor(s) 130 of the vehicle 100 may be malfunctioning, obstructed, or otherwise offline. As another example, the object identification module(s) 170 and/or the processors 110 may not be able to identify a pedestrian from the sensor data acquired by the sensor(s) 130. In such cases, the pedestrian perception module(s) 180 can receive historical data 124 relating to pedestrian traffic in the area (e.g., data relating to the number of pedestrians present at a particular time of day, etc.). Based on the historical data 124, the pedestrian perception module(s) 180 can determine the likelihood that one or more pedestrians are present in the area of the vehicle 100.

When the pedestrian perception module(s) determines that there is a high likelihood (e.g., about 70% or greater, about 75% or greater, about 80% or greater, about 85% or greater, about 90% or greater, about 95% or greater, etc.) based on the historical data 124, then the pedestrian perception module(s) 180 can assume and determine that the eye trajectory of a pedestrian is moving toward a direction that is opposite the travel direction of the vehicle 100. In such case, the pedestrian perception module(s) 180 can take action to cause the pedestrian's perception of the vehicle 100 to be modified.

On the other hand, when the pedestrian perception module(s) determines that there is a low likelihood (e.g., about 30% or less, about 25% or less, about 20% or less, about 15% or less, about 10% or less, about 5% or less, etc.) based on the historical data 124, then the pedestrian perception module(s) 180 can assume and determine that the eye trajectory of a pedestrian is not moving toward a direction that is opposite the travel direction of the vehicle 100. In such case, the pedestrian perception module(s) 180 can take no action.

In some arrangements, the pedestrian perception module(s) 180 can cause pedestrian perception of the vehicle 100 to be modified in areas that vehicles appear aggressive to pedestrians even without sensor data relating to the pedestrian's eye trajectory and without historical pedestrian traffic information. For example, the pedestrian perception module(s) 180 can cause pedestrian perception of the vehicle 100 to be modified when approaching a pedestrian who is looking away from the vehicle 100.

The pedestrian's perception of the vehicle 100 can be modified in various ways. The modification can be implemented by one or more control modules 185 and/or one or more driving module(s) 190. Various examples of modifications to a pedestrian's perception will be described herein.

The vehicle 100 can include one or more control modules 185. The control module(s) 185 can be configured to perform various actions. For instance, the control module(s) 185 can be configured to send instructions or commands to one or more extended reality devices worn or otherwise carried by a pedestrian in the external environment of the vehicle 100. For instance, the control module(s) 185 can be configured to send instructions or commands to cause an extended reality device to modify the presentation of the vehicle 100 within the extended reality device. As an example, the control module(s) 185 can be configured to cause the size of the vehicle 100 presented in the extended reality device to be modified. In one or more arrangements, the control module(s) 185 can cause a size of the vehicle 100 to be increased or decreased.

The modification of the size of the vehicle 100 can be achieved in any suitable manner. In some arrangements, an extended reality representation the vehicle can be modified in an extended reality device worn or otherwise carried by a pedestrian. In such case, the extended reality representation of the vehicle can be modified, such as by increasing the size of the extended reality representation of the vehicle. In one or more arrangements, all other things in the extended reality presentation can be decreased in size while the size of the extended reality representation of the vehicle is unchanged. Increasing the apparent size of the vehicle 100 in the extended reality representation can create the impression that the vehicle is moving slower than it actually is traveling, thereby creating a less aggressive perception of the vehicle 100 to the pedestrian.

In some arrangements, the vehicle can be a real-time video of the vehicle. In such case, the vehicle 100 can be magnified in the extended reality device while any other objects or things in the video remain their normal size. Alternatively, the size of the vehicle can be increased by an extended reality overlay of the vehicle that is larger than the vehicle in the real-time video. Thus, the actual vehicle would not be visible in the extended reality device.

In some arrangements, the control module(s) 185 can be configured to send commands or queries to other elements of the vehicle 100 or to other elements of a system (see, e.g., system 200 in FIG. 2). For instance, the control module(s) 185 can send commands or queries to connected vehicles, other connected devices, and/or connected infrastructure devices, which are explained in greater detail in connection with FIG. 2. In one or more arrangements, the control module(s) 185 can send instructions to an extended reality device to cause the extended reality device to modify the presentation of other vehicles within the extended reality device. For instance, if another vehicle is not configured according to arrangements described herein and that vehicle is traveling in the same direction as the vehicle 100 (e.g., a leading vehicle in the same travel lane, a trailing vehicle in the same travel lane, or a vehicle in a parallel lane), then the control module(s) 185 can send instructions to the extended reality device to cause the extended reality device to modify the presentation of the other vehicles within the extended reality device.

Further, the control module(s) 185 can send queries or requests to connected vehicles, connected devices, and connected infrastructure devices for data about a pedestrian in the external environment. Such capability can be used in addition to the data acquired by the sensor(s) 130. Alternatively, if sensor data cannot be obtained and/or if relevant things (e.g., identifying objects, detecting eye trajectory, etc.) cannot be identified in the acquired sensor data, then the control module(s) 185 can send such queries or requests.

The vehicle 100 can include one or more driving modules 190. The driving module(s) 190 can receive data from the sensor(s) 130 and/or any other type of system capable of capturing information relating to the vehicle 100 and/or the external environment of the vehicle 100. The driving module(s) 190 can determine position and velocity of the vehicle 100. The driving module(s) 190 can determine the location of objects, obstacles, or other environmental features including traffic signs, trees, shrubs, neighboring vehicles, pedestrians, etc.

The driving module(s) 190 can determine travel path(s), current driving maneuvers for the vehicle 100, future driving maneuvers and/or modifications to current driving maneuvers based on data acquired by the sensor(s) 130, driving scene models, and/or data from any other suitable source. “Driving maneuver” means one or more actions that affect the movement of a vehicle. Examples of driving maneuvers can include accelerating, decelerating, braking, turning, moving in a lateral direction of the vehicle 100, changing travel lanes, merging into a travel lane, and/or reversing, just to name a few possibilities. The driving module(s) 190 can cause, directly or indirectly, such driving maneuvers to be implemented. As used herein, “cause” or “causing” means to make, force, compel, direct, command, instruct, and/or enable an event or action to occur or at least be in a state where such event or action may occur, either in a direct or indirect manner.

The driving module(s) 190 can execute various vehicle functions and/or to transmit data to, receive data from, interact with, and/or control the vehicle 100 or one or more systems thereof. In some arrangements, the driving module(s) 190 and/or the processor(s) 110 can send signals to one or more actuators to modify, adjust and/or alter one or more vehicle systems or components thereof. The actuators can include motors, pneumatic actuators, hydraulic pistons, mechanical actuators, electromechanical actuators, relays, solenoids, and/or piezoelectric actuators, just to name a few possibilities.

The processor(s) 110 and/or the driving module(s) 190 can be operatively connected to communicate with various vehicle systems and/or individual components thereof. For example, the processor(s) 110 and/or the driving module(s) 190 can be in communication to send and/or receive information from various vehicle systems to control the movement, speed, maneuvering, heading, direction, etc. of the vehicle 100. The processor(s) 110 and/or the driving module(s) 190 may control some or all of these vehicle systems and, thus, may be partially or fully autonomous. For instance, when operating in an autonomous mode, the processor(s) 110 and/or the driving module(s) 190 can control the direction and/or speed of the vehicle 100. The processor(s) 110 and/or the driving module(s) 190 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels).

In some arrangements, the driving module(s) 190 and/or the processor(s) 110 can be configured to cause a speed of the vehicle 100 to be reduced when it is determined that the eye trajectory of the pedestrian moves toward the direction that is opposite a travel direction of a vehicle. Such a decrease in speed can be based on a fixed or predetermined amount or percentage. As an example, the speed can be reduced by about 5% or less, about 10% or less, about 15% or less, or about 20% or less. As another example, the speed can be reduced by 5 units (e.g., miles per hour or kilometers per hour) or less, about 10 units or less, about 15 units or less, or about 20 units or less. In some arrangements, the decrease in speed can be a non-fixed or non-predetermined amount.

In some arrangements, the amount of decrease can be dynamically adjusted based on real-time conditions of the vehicle 100. For instance, the speed of the vehicle 100 can be decreased by an additional amount (e.g., more than the standard amount) when the vehicle is located in a rural environment, as determined by the pedestrian perception module(s) 180 as described above. As another example, the speed of the vehicle 100 can be decreased by an additional amount based on characteristics of the pedestrian. For instance, if the pedestrian is determined to be a shy person, then the speed of the vehicle 100 can be reduced by an additional amount.

It should be noted that arrangements described herein can include a plurality of modifications to the pedestrian's perception of the vehicle. For instance, when the pedestrian is wearing an extended reality device, the size of the vehicle presented in the extended reality device can be increased and the speed of the vehicle can be decreased.

The various elements of the vehicle 100 can be communicatively linked through one or more communication networks 195. As used herein, the term “communicatively linked” can include direct or indirect connections through a communication channel or pathway or another component or system. A “communication network” means one or more components designed to transmit and/or receive information from one source to another. The communication network(s) 195 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network(s) 195 further can be implemented as or include one or more wireless networks, whether short or long range. For example, in terms of short range wireless networks, the communication network(s) 195 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network(s) 195 can include a mobile, cellular, and or satellite-based wireless network and support voice, video, text, and/or any combination thereof. Examples of long range wireless networks can include GSM, TDMA, CDMA, WCDMA networks or the like. The communication network(s) 195 can include wired communication links and/or wireless communication links. The communication network(s) 195 can include any combination of the above networks and/or other types of networks. The communication network(s) 195 can include one or more routers, switches, access points, wireless access points, and/or the like. In one or more arrangements, the communication network(s) 195 can include Vehicle-to-Vehicle (V2V), Vehicle-to-Infrastructure (V2I), Vehicle-to-Cloud (V2C), or Vehicle-to-Everything (V2X) technology.

One or more elements of the vehicle 100 include and/or can execute suitable communication software, which enables two or more of the elements to communicate with each other through the communication network(s) 195 and perform the functions disclosed herein.

FIG. 2 is an example of a system 200 for modifying pedestrian perception of a vehicle. Some of the possible elements of the system 200 are shown in FIG. 2 and will now be described. It will be understood that it is not necessary for the system 200 to have all of the elements shown in FIG. 2 or described herein.

The various elements of the system 200 can be communicatively linked through one or more communication networks 295. The above discussion of the communication network(s) 195 in connection with FIG. 1 applies equally to the communication network(s) 295. In one or more arrangements, the communication network(s) 295 can include Vehicle-to-Vehicle (V2V), Vehicle-to-Infrastructure (V2I), Vehicle-to-Cloud (V2C), or Vehicle-to-Everything (V2X) technology, which can allow for communications between the vehicle 100, the connected entities 250, and/or the server(s) 240. One or more elements of the system 200 include and/or can execute suitable communication software, which enables two or more of the elements to communicate with each other through the communication network(s) 295 and perform the functions disclosed herein.

The system 200 can include the vehicle 100, one or more processors 210, one or more data stores 220, one or more sensors 230 (including one or more vehicle sensors 232, one or more driving environment sensors 234, and one or more pedestrian sensors 236), one or more object identification modules 270, one or more eye trajectory modules 275, one or more pedestrian perception modules 280, one or more control modules 285, and one or more driving modules 290. The above discussion of the vehicle 100, the processor(s) 110, the data store(s) 120 (including the map data 122, the historical data 124, and the object data 126), the sensor(s) 130 (including the vehicle sensor(s) 132, the driving environment sensor(s) 134, and the pedestrian sensor(s) 136), the object identification module(s) 170, the eye trajectory module(s) 175, the pedestrian perception module(s) 180, the control module(s) 185, and the driving module(s) 190 in connection with FIG. 1 applies equally to the processor(s) 210, the data store(s) 220 (including the map data 222, the historical data 224, and the object data 226), the sensor(s) 230 (including the vehicle sensor(s) 232, the driving environment sensor(s) 234, and the pedestrian sensor(s) 236), the object identification module(s) 270, the eye trajectory module(s) 275, the pedestrian perception module(s) 280, the control module(s) 285, and the driving module(s) 290, respectively. Indeed, the various module(s) in FIG. 2 can be located on the vehicle 100, one or more of the connected entities 250, the server(s) 240, or any combination thereof. In one or more arrangements, the various modules can be located remote from the vehicle 100.

The system 200 can include one or more servers 240. The server(s) 240 can be located remote from the vehicle 100 and/or the connected entities 250. The server(s) 240 can be any type of server, now known or later developed. In some arrangements, the server(s) 240 can be cloud-based server(s) or edge server(s). The server(s) 240 can communicate with the vehicle 100 and/or with the connected entities 250 over the communication network 295. In some arrangements, the processor(s) 210, the data store(s) 220, one or more of the modules, one or more other elements of the system 200, or any combination thereof can be located on the server(s) 240.

The system 200 can include one or more connected entities 250. A connected entity can include any device that is communicatively coupled to the server(s) 240 and/or the vehicle 100. Non-limiting examples of the connected entities 250 includes one or more connected vehicles 252, one or more connected infrastructure devices 256, and/or one or more connected devices 254. With respect to the connected vehicles 252, the above discussion of the vehicle 100 applies equally to the connected vehicles 252. In some arrangements, the processor(s) 210, the data store(s) 220, the sensor(s) 230, one or more of the modules, one or more other elements of the system 200, or any combination thereof can be located on one or more of the connected entities 250.

The connected device(s) 254 can include any mobile device or portable device worn or carried by a person, now known or later developed. The connected device(s) 254 can include one or more sensors for detecting data about a person associated with the connected device(s) 254. The discussion of the pedestrian sensors 136 in connection with FIG. 1 above is applicable to the sensors for detecting data about a person associated with the connected device(s) 254.

Examples of the connected device(s) 254 can include a telephone (e.g., a cellular telephone, a smart phone, etc.) a computer (e.g., a laptop, a tablet, a phablet, etc.), and/or any other a portable computing device. In one or more arrangements, the connected device(s) 254 can include a smart watch, smart eyeglasses, smart goggles, smart jewelry (e.g., neckless, earrings, bracelets, etc.), gaze tracking enabled goggles, smart contact lenses, and/or smart clothing (e.g., a shirt, hat, or other article of clothing enabled for wireless communication).

Regarding the connected infrastructure device(s) 256, an “infrastructure device” can be any device positioned along or near a road or other travel path or otherwise located in a driving environment. The connected infrastructure device(s) 256 can include one or more sensors for sensing the surrounding environment and/or for sensing pedestrians in the environment. The connected infrastructure device(s) 256 can be, for example, a CCTV camera, a roadside camera, a streetlight, traffic light, a smart traffic light, a traffic sign, a road sign, a billboard, a bridge, a building, a pole, or a tower, just to name a few possibilities. In some instances, the connected infrastructure device(s) 256 can be a road itself when the operative components are embedded therein. In some arrangements, the connected infrastructure device(s) 256 can be configured to send information to and/or receive information from the server(s) 240, the vehicle 100, one or more of the connected entities 250, one or more other elements of the system 200, or any combination thereof.

By the system 200, the vehicle 100 can send requests for map data 222 and/or historical data 224 and/or the vehicle 100 can access the map data 222 and/or the historical data 224. For example, when the vehicle 100 cannot identify a pedestrian from available sensor data, the vehicle 100 can access or receive historical data relating to pedestrian traffic in the current area of the vehicle 100. Such data can include the number of pedestrians present at a particular time of day.

The vehicle 100 can send queries or requests to one or more of the connected entities 250 for data about a pedestrian. For instance, there may be instances in which the vehicle 100 can detect the presence of a pedestrian but cannot detect the eye movement of the pedestrian, such as due to obstructions, orientation of the pedestrian, etc. In such instances, the vehicle want to acquire eye trajectory data about the pedestrian. Thus, the vehicle 100 can send request to one or more connected entities for eye trajectory data about a pedestrian. When received, the acquired eye trajectory data can be processed by the vehicle 100.

In some instances, the system 200 can send management instructions to the vehicle 100 and/or the connected entities 250. The management instructions can include instructions to modify a behavior of the vehicle 100. The management instructions can include commands that can be implemented by the vehicle to control the movement of the vehicle 100. Alternatively, the management instructions can include commands that can be implemented by an extended reality device carried by a pedestrian. The command can be to manipulate a size of the vehicle 100 as it appears in extended reality device.

In some cases, the management instructions can be a command from one vehicle to another vehicle. For instance, one vehicle may have the capability of modify a pedestrian's perception according to arrangements described herein and the other vehicle does not have such capability. As an example, a reference vehicle can determine that a modification to a pedestrian's perception of the vehicle is needed. Accordingly, the reference vehicle can reduce its speed. If there is a following vehicle (e.g., in the same travel lane) or a leading vehicle (e.g., in the same travel lane or a different travel lane) traveling in the same travel direction as the reference vehicle but such other vehicle(s) are not configured according to arrangements described herein, then the reference vehicle can send a command to the other vehicle(s) to reduce their speed, thereby modifying the pedestrian's perception of the other vehicle(s). Alternatively, such commands can be sent by a connected entity 250 or the server 240.

Now that the various potential systems, devices, elements and/or components of the vehicle 100 and the system 200 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

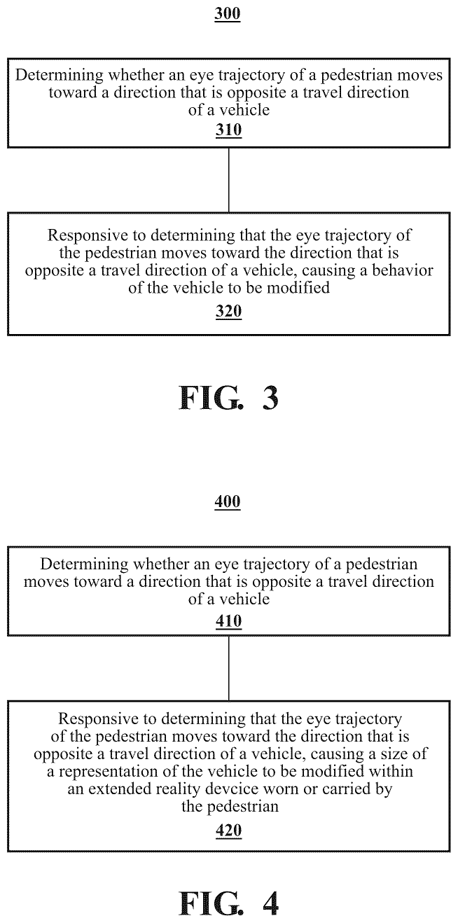

Turning to FIG. 3, a first example of a method 300 of modifying pedestrian perception of a vehicle is shown. At block 310, the method 300 can include determining whether an eye trajectory of a pedestrian moves toward a direction that is opposite a travel direction of a vehicle. Such determining can be performed by the processor(s) 110, the eye trajectory module(s) 175, and/or the pedestrian perception module(s) 180. The determining can be performed based on data acquired by the vehicle sensor(s) 132 and the pedestrian sensor(s) 136. The method 300 can continue to block 320.

At block 320, responsive to determining that the eye trajectory of the pedestrian moves toward the direction that is opposite a travel direction of a vehicle, the method 300 can include causing a behavior of the vehicle to be modified. The causing can be performed by the control module(s) 185, the driving module(s) 190, and/or the processor(s) 110. In one or more arrangements, the causing the behavior of the vehicle to be modified can include reducing the speed of the vehicle.

The method 300 can end. Alternatively, the method 300 can return to block 310 or to some other block. The method 300 can be repeated at any suitable point, such as at a suitable time or upon the occurrence of any suitable event or condition.

FIG. 4 is a second example of a method 400 of modifying pedestrian perception of a vehicle. At block 410, the method 400 can include determining whether an eye trajectory of a pedestrian moves toward a direction that is opposite a travel direction of a vehicle. Such determining can be performed by the processor(s) 110, the eye trajectory module(s) 175, and/or the pedestrian perception module(s) 180. The determining can be performed based on data acquired by the vehicle sensor(s) 132 and the pedestrian sensor(s) 136. The method 300 can continue to block 420.

At block 420, responsive to determining that the eye trajectory of the pedestrian moves toward the direction that is opposite a travel direction of a vehicle, the method 400 can include causing a size of the vehicle to be modified within a head mounted extended reality display device worn by the pedestrian. The causing can be performed by the control module(s) 185 and/or the processor(s) 110. In one or more arrangements, the causing the size of the vehicle to the modified includes causing the size of the vehicle to be increased. The vehicle can be an extended reality representation the vehicle. In such case, the extended reality representation of the vehicle can be increased. In some arrangements, the vehicle can be a real-time video of the vehicle, and the size of the vehicle can be increased by an extended reality overlay of the vehicle that is larger than the vehicle in the real-time video.

The method 400 can end. Alternatively, the method 400 can return to block 410 or to some other block. The method 400 can be repeated at any suitable point, such as at a suitable time or upon the occurrence of any suitable event or condition.

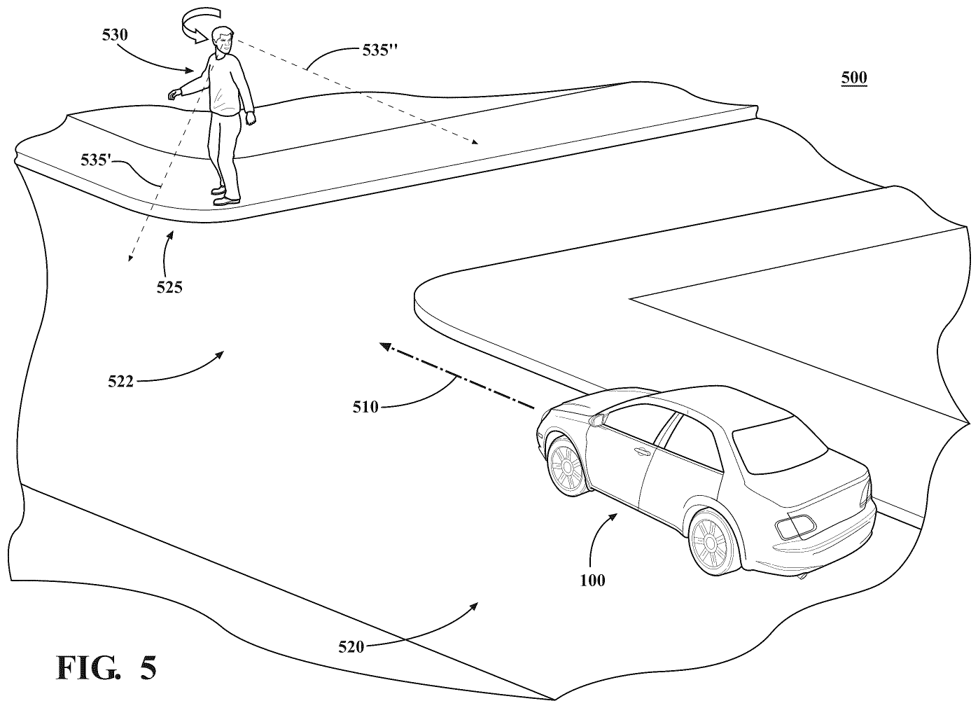

Non-limiting examples of the operation of the arrangements described herein will now be presented. Referring to FIG. 5, an example of a driving scenario 500 is shown. In this example, the vehicle 100 can be moving in a travel direction 510 on a road 520. The vehicle 100 can be approaching an intersection 522. A pedestrian 530 can be standing at a corner 525 at or near the intersection 522.

The vehicle 100 can determine the travel direction 510 based on the vehicle sensors 132 or the navigation system(s) 165. The vehicle 100 can use one or more of the sensors 130 to detect the presence of the pedestrian 530. For instance, the vehicle 100 can detect the pedestrian 530 using the driving environment sensors(s) 134 (e.g., cameras) and/or the pedestrian sensor(s) 136. For instance, the object identification module(s) 170 and/or the processor(s) 110 can analyze data acquired by the driving environment sensors(s) 134 and/or the pedestrian sensor(s) 136 to identify that the object is a person.

The vehicle 100 can determine an initial eye trajectory 535′ of the pedestrian 530. The vehicle 100 can monitor the eye trajectory of the pedestrian 530 over time. The vehicle 100 can use one or more of the sensors 130 to acquire data about eye and/or head movements of the pedestrian 530. Alternatively or additionally, the vehicle 100 can receive data from one or more connected entities 250 about eye and/or head movements of the pedestrian 530. Using the data about eye and/or head movements of the pedestrian 530, the eye trajectory module(s) 175 can determine and track the eye trajectory of the pedestrian 530 over time.

The pedestrian perception module(s) 180 can determine whether the eye trajectory of the pedestrian 530 moves toward a direction that is opposite the travel direction 510 of a vehicle 100. The pedestrian perception module(s) 180 can compare the eye trajectory (or changes to the eye trajectory) of the pedestrian 530 to the travel direction 510 of the vehicle 100. The pedestrian perception module(s) 180 can compare the eye trajectory (or changes to the eye trajectory) of the pedestrian 530 to the travel direction 510 of the vehicle 100 at substantially the same moment in time. Such comparing can be performed continuously, periodically, irregularly, or even randomly.

In this example, the pedestrian 530 can initially be facing at about 90 degrees from the travel direction 510 of the vehicle 100 as it approaches. For instance, the pedestrian 530 can be looking to straight ahead while the vehicle 100 is approaching from the left. The pedestrian 530 can rotate his or her head (and eyes) to the left to view the approaching vehicle 100. Thus, the eye trajectory of the pedestrian 530 can change to a subsequent eye trajectory 535″. As a result, the angle between the eye trajectory and the vehicle travel direction can go from about 90 degrees to about 0 degrees. However, the vehicle 100 will appear to the pedestrian 530 to be approaching at a faster or more aggressive speed than it actually is traveling due to the opposing trajectories (e.g., the subsequent eye trajectory 535″ of pedestrian 530 vs travel direction 510 of the vehicle 100).

Thus, the pedestrian perception module(s) 180 can determine that the eye trajectory of the pedestrian 530 is moving toward a direction that is opposite to the travel direction 510 of the vehicle 100. As a result, the vehicle 100 can cause the perception of the vehicle 100 by the pedestrian 530 to be modified. In this instance, the speed of the vehicle 100 can be decreased by the driving module(s) 190 and/or the processor(s) 110. Such a decrease in speed will compensate for the pedestrian's perceived overestimation of speed, which can make the vehicle 100 appear less threatening to the pedestrian 530 and can make the pedestrian 530 feel safer.

After the vehicle 100 passes the pedestrian 530 and/or it is determined that the eye trajectory of the pedestrian 530 is moving toward a direction that is the same as the travel direction of the vehicle, the vehicle 100 can resume its previous speed or otherwise increase its speed.

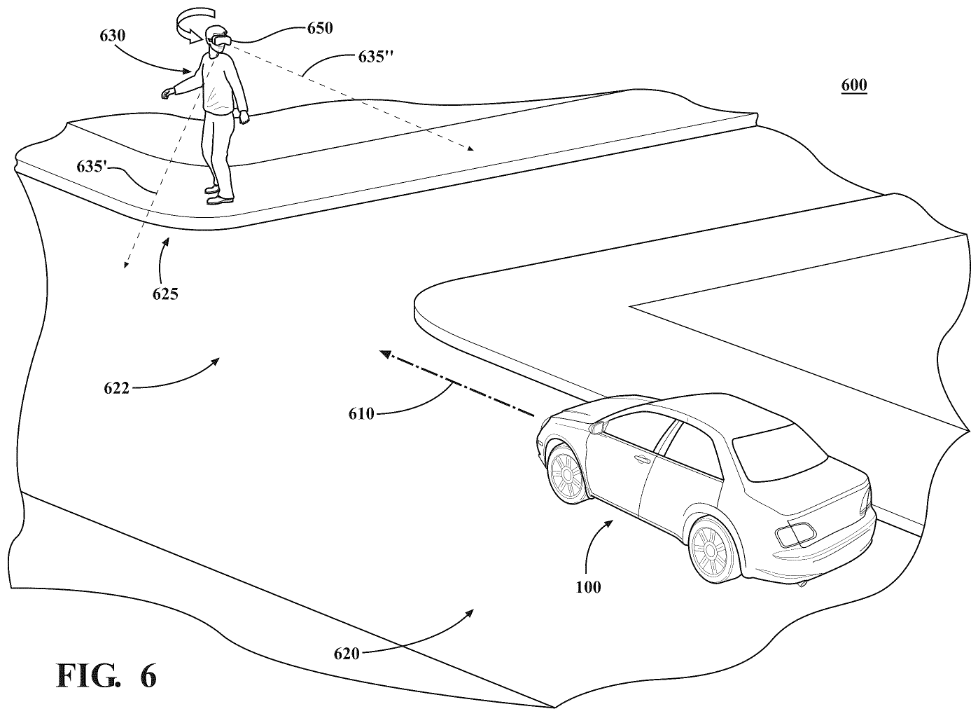

Referring to FIG. 6, an example of a driving scenario 600 is shown. In this example, the vehicle 100 can be moving in a travel direction 610 on a road 620. The vehicle 100 can be approaching an intersection 622. A pedestrian 630 can be standing at a corner 625 at or near the intersection 622. The pedestrian 630 can be wearing an extended reality display device, such as an extended reality headset 650.

The vehicle 100 can determine the travel direction 610 based on the vehicle sensors 132 or the navigation system(s) 165. The vehicle 100 can use one or more of the sensors 130 to detect the presence of the pedestrian 630. For instance, the vehicle 100 can detect the pedestrian 630 using the driving environment sensors(s) 134 (e.g., cameras) and/or the pedestrian sensor(s) 136. For instance, the object identification module(s) 170 and/or the processor(s) 110 can analyze data acquired by the driving environment sensors(s) 134 and/or the pedestrian sensor(s) 136 to identify that the object is a person. In the same way, the extended reality headset 650 can be detected.

The vehicle 100 can determine an initial eye trajectory 635′ of the pedestrian 530. The vehicle 100 can monitor an eye trajectory of the pedestrian 630 over time. The vehicle 100 can use one or more of the sensors 130 to acquire data about eye and/or head movements of the pedestrian 630. Alternatively or additionally, the vehicle 100 can receive data from one or more connected entities 250 about eye and/or head movements of the pedestrian 630. Using the data about eye and/or head movements of the pedestrian 630 and/or movements of the extended reality headset 650, the eye trajectory module(s) 175 can determine and track the eye trajectory of the pedestrian 630 over time.

The pedestrian perception module(s) 180 can determine whether the eye trajectory of the pedestrian 630 moves toward a direction that is opposite the travel direction 610 of a vehicle 100. The pedestrian perception module(s) 180 can compare the eye trajectory (or changes to the eye trajectory) of the pedestrian 630 to the travel direction 610 of the vehicle 100. The pedestrian perception module(s) 180 can compare the eye trajectory (or changes to the eye trajectory) of the pedestrian 630 to the travel direction 610 of the vehicle 100 at substantially the same moment in time. Such comparing can be performed continuously, periodically, irregularly, or even randomly.

In this example, the pedestrian 630 can initially be facing at about 90 degrees from the travel direction 610 of the vehicle 100 as it approaches. For instance, the pedestrian 630 can be looking to straight ahead while the vehicle 100 is approaching from the left. The pedestrian 630 can rotate his or her head (and eyes) to the left to view the approaching vehicle 100. Thus, the eye trajectory of the pedestrian 630 can change to a subsequent eye trajectory 635″. As a result, the angle between the eye trajectory and the vehicle travel direction can go from about 90 degrees to about 0 degrees. However, the vehicle 100 will appear to the pedestrian 630 to be approaching at a faster or more aggressive speed than it actually is traveling due to the opposing trajectories (e.g., the subsequent eye trajectory 635″ of pedestrian 630 vs travel direction 610 of the vehicle 100).

Thus, the pedestrian perception module(s) 180 can determine that the eye trajectory of the pedestrian 630 is moving toward a direction that is opposite to the travel direction of the vehicle 100. As a result, the vehicle 100 can cause the perception of the vehicle 100 by the pedestrian 630 to be modified. Such modification can mitigate the pedestrian's overestimation of speed. In this instance, the size of the vehicle 100 can be manipulated within the extended reality headset 650 to make the vehicle 100 appear that it is traveling at a lower speed than it actually is. Here, the vehicle 100 can be made to appear larger than it actually is within the extended reality headset 650. The manipulation of the size of the vehicle 100 can be performed by the control module(s) 185 and/or the processor(s) 110. For instance, the control module(s) 185 and/or the processor(s) 110 can send a command to the extended reality headset 650 to cause the extended reality headset 650 to display the vehicle 100 in an enlarged form.

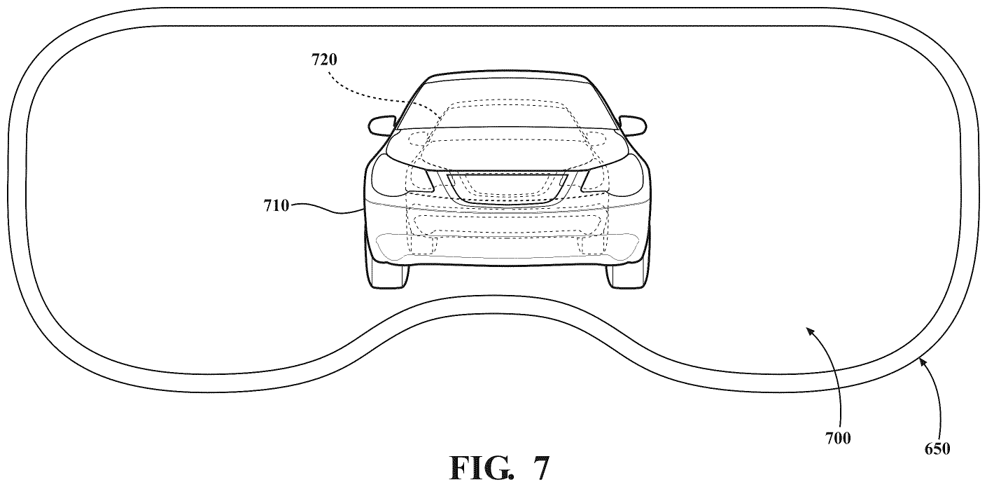

An example of a pedestrian's view of the vehicle 100 within the extended reality headset 650 is shown in FIG. 7. The extended reality headset 650 can include a display 700. The vehicle 100 can appear on the display 700. According to arrangements herein, the presentation of the vehicle 100 on the display 700 can be modified. In this example, a size of an extended reality representation 710 of the vehicle 100 can modified to be make the vehicle 100 appear larger than it would usually appear in the extended reality headset 650, either as an actual presentation of the vehicle or as an extended reality representation of the vehicle (both of which are represented by 720). As a result, the pedestrian can be caused to underestimate the perceived speed of the vehicle 100, which will make the vehicle 100 appear to be less aggressive which will make the pedestrian 630 feel safer.

Thus, the increase of the size of the vehicle 100 in the extended reality headset 650 can compensate for the pedestrian's perceived aggressiveness of the vehicle 100. Increasing the size of the vehicle 100 in the extended reality headset 650 can make the vehicle 100 appear less threatening to the pedestrian 630 and can make the pedestrian 630 feel safer.

After the vehicle 100 passes the pedestrian 630 and/or it is determined that the eye trajectory of the pedestrian 630 is moving toward a direction that is the same as the travel direction of the vehicle, the increase in size of the vehicle 100 in the extended reality headset 650 can, in some arrangements, be discontinued. Thus, the vehicle 100 can appear as it normally would in the extended reality headset 650 without any modification to its size.

It will be appreciated that arrangements described herein can provide numerous benefits, including one or more of the benefits mentioned herein. For example, arrangements described herein can improve a pedestrian's perceived feeling of safety. Arrangements described herein can reduce pedestrian fear, particularly in situations when the pedestrian is not looking at an approaching vehicle and then turns toward it. Arrangements described herein can be implemented in a way to minimize environmental impact. Arrangements described herein can boost societal acceptance of autonomous vehicles. Arrangements described herein can help to move the world closer to a zero-fatality mobility society.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

1. A method, comprising:
determining whether an eye trajectory of a pedestrian moves toward a direction that is opposite a travel direction of a vehicle, the determining including:
detecting a pedestrian in an environment of the vehicle;
acquiring eye trajectory data of the pedestrian; and
comparing the acquired eye trajectory data to a travel direction of the vehicle; and
responsive to determining that the eye trajectory of the pedestrian moves toward the direction that is opposite the travel direction of the vehicle, causing a perception of the vehicle by the pedestrian to be modified.

2. The method of claim 1, wherein causing a perception of the vehicle by the pedestrian to be modified includes causing a behavior of the vehicle to be modified.

3. The method of claim 2, wherein causing a behavior of the vehicle to be modified includes decreasing a speed of the vehicle.

4. The method of claim 1, further including:
determining whether the vehicle is located in a rural environment; and
when the vehicle is determined to be located in a rural environment, causing the perception of the vehicle by the pedestrian to be modified includes causing a degree of modification to be increased.

5. (canceled)

6. The method of claim 1, wherein acquiring eye trajectory data of the pedestrian is performed by one or more pedestrian sensors carried on the vehicle.

7. The method of claim 1, wherein acquiring eye trajectory data of the pedestrian is performed by one or more infrastructure devices.

8. The method of claim 1, wherein acquiring eye trajectory data of the pedestrian is performed by receiving eye trajectory data from a mobile device of the pedestrian.

9. The method of claim 1, wherein causing a perception of the vehicle by the pedestrian to be modified includes causing a size of an extended reality representation of the vehicle to be modified in an extended reality display device carried or worn by the pedestrian.

10. The method of claim 9, wherein causing the size of the extended reality representation the vehicle to be modified in an extended reality display device carried or worn by the pedestrian includes causing the size of the extended reality representation of the vehicle to be increased in the extended reality display device carried or worn by the pedestrian.

11. A system, comprising:
one or more processors programmed to initiate executable operations, the executable operations including:
determining whether an eye trajectory of a pedestrian moves toward a direction that is opposite a travel direction of a vehicle, the determining including:
detecting a pedestrian in an environment of the vehicle;
acquiring eye trajectory data of the pedestrian; and
comparing the acquired eye trajectory data to a travel direction of the vehicle; and
responsive to determining that the eye trajectory of the pedestrian moves toward the direction that is opposite the travel direction of the vehicle, causing a perception of the vehicle by the pedestrian to be modified.

12. The system of claim 11, wherein the one or more processors are carried on the vehicle.

13. The system of claim 11, wherein causing a perception of the vehicle by the pedestrian to be modified includes causing a behavior of the vehicle to be modified.

14. The system of claim 13, wherein causing a behavior of the vehicle to be modified includes decreasing a speed of the vehicle.

15. The system of claim 11, wherein the executable operations further include:
determining whether the vehicle is located in a rural environment; and
when the vehicle is determined to be located in a rural environment, causing the perception of the vehicle by the pedestrian to be modified includes causing a degree of modification to be increased.

16. (canceled)

17. The system of claim 11, further including one or more pedestrian sensors carried on the vehicle, wherein the one or more pedestrian sensors are operatively connected to the one or more processors, and wherein acquiring eye trajectory data of the pedestrian is performed by one or more pedestrian sensors.

18. The system of claim 11, wherein acquiring eye trajectory data of the pedestrian includes receiving the eye trajectory data from one or more infrastructure devices, and wherein the one or more infrastructure devices are operatively connected to the one or more processors.

19. The system of claim 11, wherein acquiring eye trajectory data of the pedestrian includes receiving the eye trajectory data from a mobile device of a pedestrian, and wherein the mobile device is operatively connected to the one or more processors.

20. The system of claim 11, wherein causing a perception of the vehicle by the pedestrian to be modified includes causing a size of the vehicle presented in an extended reality device worn or carried by the pedestrian to be modified.

21. The system of claim 20, wherein causing the size of the vehicle presented in the extended reality device worn or carried by the pedestrian to be modified includes causing the size of the vehicle to be increased in the extended reality device worn or carried by the pedestrian.
